(19) United States
(12) Patent Application Publication
(10) Pub. No.: US 2023/0354859 A1
(43) Pub. Date: Nov. 9, 2023

(54) OIL-IN-WATER EMULSIFIED SEASONING, AND METHOD FOR PRODUCING SAME

(71) Applicant: The Nisshin OilliO Group, Ltd., Tokyo (JP)

(72) Inventors: Hidetoshi Ishikawa, Yokohama-shi, Kanagawa (JP); Yasunobu Saito, Yokohama-shi, Kanagawa (JP)

(73) Assignee: The Nisshin OilliO Group, Ltd., Tokyo (JP)

(21) Appl. No.: 18/026,473

(22) PCT Filed: Sep. 22, 2021
(86) PCT No.: PCT/JP2021/034740

§ 371 Date: Mar. 15, 2023

(30) Foreign Application Priority Data
Sep. 28, 2020 (JP) 2020-161913
Jul. 30, 2021 (JP) 2021-124938

(51) Int. Cl. A23L 27/00; A23L 27/60

(52) U.S. Cl. CPC A23L 27/80; A23L 27/60

(57) ABSTRACT

The present invention addresses the problem of providing an oil-in-water emulsified seasoning in which deterioration of flavor over time is suppressed, and a method for producing the oil-in-water emulsified seasoning. The present invention is an oil-in-water emulsified seasoning containing 25-75 mass % of an oil and fat, 5-50 mass ppm of β-carotene, and 1-5 mass ppm of lycopene, wherein the β-carotene is contained in the oil and fat, and the lycopene is contained in a continuous phase. The present invention is also a method for producing an oil-in-water emulsified seasoning, the method involving emulsifying an oil phase that contains the oil and fat and the β-carotene, and an aqueous phase that contains the lycopene.

### TECHNICAL FIELD

The present invention relates to an oil-in-water emulsified seasoning and a method for producing the same.

### BACKGROUND OF THE INVENTION

Oil-in-water emulsified seasonings such as emulsified dressings, mayonnaise, and dipping sauces are seasonings used in various dishes including salads, etc., and are widely popular and used by everyone. Oil-in-water emulsified seasonings are generally produced by preparing an aqueous phase containing water, and then adding an oil phase containing an oil-and/or-fat to the aqueous phase and emulsifying together. Oil-in-water emulsified seasonings circulated as merchandise are required to have a stable quality for a long time (i.e., long shelf life), but have a problem that oxidation of oil-and/or-fat progresses over time due to the presence of the aqueous phase and dissolved oxygen and causes degradation in flavor.

Thus, some attempts have been made to suppress the oxidation of oil-and/or-fat by sealing oil-in-water emulsified seasonings in resin containers with oxygen barrier properties or by incorporating an antioxidant into the oil phase. However, it is difficult to suppress degradation in flavor over time.

A method for preventing the degradation of mayonnaise characterized by the addition of tea polyphenol (Patent Literature 1) and an oil-in-water emulsified food product packaged in a container so that a ratio of an empty space in the container to the filled oil-in-water emulsified food product is 0.007 to 0.125 and an oxygen concentration in the empty space in the container is 0.4 to 13.7% (Patent Literature 2) have been reported so far, but there is a demand for a method for suppressing flavor degradation in long-term storage.

### CITATION LIST

### Patent Literatures

Patent Literature 1: JPH4-20262A
Patent Literature 2: JP2013-240285A

### SUMMARY OF THE INVENTION

### Problem to be Solved by the Invention

In view of the above-mentioned problems, it is an object of the invention to provide an oil-in-water emulsified seasoning with suppressed flavor degradation over time, and a method for producing such an oil-in-water emulsified seasoning.

### Means for Solving the Problem

The present inventors found that flavor degradation over time due to oxidative degradation of oil-and/or-fat is suppressed when an oil-in-water emulsified seasoning contains a specific amount of β-carotene in the oil phase and a specific amount of lycopene in the continuous phase (the aqueous phase), and the present invention was completed. In detail, the invention provides the following aspects.

(1) An oil-in-water emulsified seasoning containing 25 to 75 mass % of an oil-and/or-fat; 5 to 50 mass ppm of β-carotene; and 1 to 5 mass ppm of lycopene, wherein the β-carotene is contained in the oil-and/or-fat and the lycopene is contained in a continuous phase.

(2) The oil-in-water emulsified seasoning as described in (1) further containing 0.5 to 5 mass % of a modified starch.

(3) The oil-in-water emulsified seasoning as described in (1) or (2), wherein an unsaturated fatty acid content in the total constituent fatty acids of the oil-and/or-fat is not less than 65 mass %.

(4) A method for producing the oil-in-water emulsified seasoning as described by any one of (1) to (3) including emulsifying an oil phase containing the oil-and/or-fat and the β-carotene, and an aqueous phase containing the lycopene.

(5) A method for producing the oil-in-water emulsified seasoning as described by any one of (1) to (3) including dispersing the lycopene in a continuous phase after emulsifying an oil phase containing the oil-and/or-fat and the β-carotene, and an aqueous phase.

### Advantageous Effects of the Invention

The invention provides an oil-in-water emulsified seasoning with suppressed flavor degradation over time achieved by containing a specific amount of β-carotene in the oil-and/or-fat and a specific amount of lycopene in the continuous phase, and a method for producing such an oil-in-water emulsified seasoning. Here, the term “flavor degradation over time” in the invention refers to abnormal odor and abnormal taste (bitter astringency) caused by oxidative degradation over time of the oil-and/or-fat contained in the oil-in-water emulsified seasoning of the present invention.

### MODE FOR CARRYING OUT THE INVENTION

A specific embodiment of the invention will be described in detail below. However, the invention is not limited in any way to the embodiment below and can be appropriately changed and implemented within the scope of the object of the invention. It should be noted that preferred forms and more preferred forms, etc., exemplified below can be used in an appropriate combination, regardless of the expressions of “preferred” and “more preferred”. In addition, numerical ranges mentioned are examples, and ranges obtained by appropriately combining the upper and lower limits of each range and numerical values in Examples can also be used preferably, regardless of the expressions of “preferred” and “more preferred”. Furthermore, the terms “contain” or “include”, etc., may be appropriately read as “composed essentially of” or “composed of only”.

Oil-In-Water Emulsified Seasoning

The oil-in-water emulsion seasoning of the invention contains an oil-and/or-fat containing β-carotene, and also contains lycopene in a continuous phase of oil-in-water emulsion (i.e., an aqueous phase).

Specific examples of the oil-in-water emulsified seasoning of the invention include semi-solid dressing, emulsified liquid dressing, mayonnaise, and salad creamy dressing that are defined in Japanese Agricultural Standards (JAS), but it is not specifically limited thereto, and seasonings, which are widely recognized as a type of mayonnaise, mayonnaise-like food, a type of dressing and dressing-like food and are in the oil-in-water emulsion form, are also included.

The oil-in-water emulsified seasoning of the invention is preferably in the form of mayonnaise, mayonnaise-like food, or dipping sauce. When the oil-in-water emulsified seasoning of the invention is mayonnaise, mayonnaise-like food, or dip source, its viscosity at 20° C. is preferably 50 to 350 Pas, more preferably 75 to 300 Pas, most preferably 100 to 250 Pas. When the viscosity at 20° C. is within the above ranges, the effects of the invention are easily obtained. The viscosity of the oil-in-water emulsified seasoning of the invention is determined by using a BH-type viscometer and measuring a value when a rotor #6 is turned twice at a rotation speed of 2 rpm.

The oil-in-water emulsified seasoning of the invention preferably has an acidity of 0.5 to 1.5 expressed in terms of acetic acid. When the oil-in-water emulsified seasoning of the invention has the acidity within the above range expressed in terms of acetic acid, the effects of the invention are easily obtained. The acidity expressed in terms of acetic acid here is measured by the following method (the neutralization titration method). 25 ml of a sample is precisely taken and diluted ten times with water. Then, 25 ml of the diluted sample is taken and placed in a flask to which two drops of phenolphthalein as an indicator are added, and the mixture is titrated with a 0.1N sodium hydroxide solution with a known factor, and the value is obtained by the following formula:

Acidity expressed in terms of acetic acid (%)=0.006×V×F×(the total amount of the diluted solution (250 ml)/(the taken amount of the diluted sample (25 ml))×(1/the taken amount of the sample (25 ml))×100
V: average volume (ml) of 0.1N NaOH standard solution used for titration
F: factor of 0.1N NaOH standard solution

Oil-and/or-Fat

The oil-and/or-fat contained in the oil-in-water emulsified seasoning of the invention is not specifically limited as long as it is edible oil-and/or-fat. Examples of the oil-and/or-fat include soybean oil, high-oleic soybean oil, rapeseed oil, high-oleic rapeseed oil, corn oil, sesame oil, sesame salad oil, perilla oil, linseed oil, peanut oil, safflower oil, high-oleic safflower oil, sunflower oil, high-oleic sunflower oil, cottonseed oil, grapeseed oil, macadamia nut oil, hazelnut oil, pumpkin seed oil, walnut oil, camellia oil, tea seed oil, Perilla frutescens seed oil, borage oil, olive oil, rice bran oil, wheat germ oil, palm oil, palm kernel oil, coconut oil, medium-chain fatty acid oil, cacao butter, beef tallow, lard, chicken oil, milkfat, fish oil, seal oil, and algae oil, etc., and also transesterified oils-and/or-fats obtained by transesterification of two or more of these oils-and/or-fats, hydrogenated oils-and/or-fats obtained by hydrogenation of these oils-and/or-fats, and fractionated oils-and/or-fats obtained by fractionation of these oils-and/or-fats, etc. The above-listed oils-and/or-fats may be used alone or may be used as a mixture of two or more thereof.

In addition, the oil-and/or-fat blended in the oil-in-water emulsified seasoning of the invention is preferably oil-and/or-fat which is in the form of liquid at 20° C. Example of the oil-and/or-fat which is in the form of liquid at 20° C. include soybean oil, high-oleic soybean oil, rapeseed oil, high-oleic rapeseed oil, corn oil, sesame oil, sesame salad oil, perilla oil, linseed oil, peanut oil, safflower oil, high-oleic safflower oil, sunflower oil, high-oleic sunflower oil, cottonseed oil, grapeseed oil, macadamia nut oil, hazelnut oil, Perilla frutescens seed oil, borage oil, olive oil, rice bran oil, wheat germ oil, and medium-chain fatty acid oil, etc.

An oil-and/or-fat content in the oil-in-water emulsified seasoning of the invention is 25 to 75 mass %. The oil-and/or-fat content in the oil-in-water emulsified seasoning of the invention is preferably 35 to 70 mass %, more preferably 45 to 70 mass %, and most preferably 50 to 65 mass %. When the oil-and/or-fat content is within the above ranges, the oil-in-water emulsified seasoning of the invention has an excellent rich taste, and in addition to this, flavor degradation over time is further suppressed. On the other hand, when the oil-and/or-fat content is less than 25 mass %, the effects of the present invention are less likely to be obtained since the influence of flavor degradation due to oxidative degradation of the oil-and/or-fat is less likely to be prominent. When the oil-and/or-fat content is more than 75 mass %, the aqueous phase content is low, resulting in poor emulsion stability.

Regarding the oil-and/or-fat contained in the oil-in-water emulsified seasoning of the invention, a proportion of an unsaturated fatty acid in the total constituent fatty acids of the oil-and/or-fat is preferably not less than 65 mass %, more preferably 65 to 98 mass %, even more preferably 70 to 98 mass %, most preferably 70 to 95 mass %, and most preferably 75 to 95 mass %. The unsaturated fatty acid content in the total constituent fatty acids of the oil-and/or-fat can be measured and calculated according to AOCS Celf-96.

β-carotene

The β-carotene contained in the oil-in-water emulsified seasoning of the invention is not specifically limited as long as it is edible β-carotene. As the β-carotene, it is possible to use extracts derived from plants such as carrot, parsley, chili pepper, palm, and marigold, or chemically synthesized β-carotene. For the β-carotene, a β-carotene preparation in which β-carotene is suspended in liquid oil-and/or-fat may be used. Carrot Oil NO. 40600 (β-carotene content: 1 mass %, manufactured by San-Ei Gen F.F.I., Inc.) and DavosLife Biocarotene PMC30 SFO (β-carotene content: 30 to 34.5 mass %, manufactured by San-Ei Gen F.F.I., Inc.) can be listed as examples of commercially available β-carotene preparation.

The β-carotene content in the oil-in-water emulsified seasoning of the invention is 5 to 50 mass ppm, and β-carotene is contained in the oil-and/or-fat used in the invention. The β-carotene content in the oil-in-water emulsified seasoning of the invention is preferably 7 to 40 mass ppm, more preferably 10 to 30 mass ppm, and most preferably 15 to 25 mass ppm. When the β-carotene content is not less than 5 mass ppm, flavor degradation over time of the oil-in-water emulsified seasoning of the invention is further suppressed. On the other hand, the β-carotene content of more than 50 mass ppm is not preferable because of strong yellow coloration.

When a β-carotene preparation is used as an ingredient of the oil-in-water emulsified seasoning of the invention, the amount of the β-carotene preparation to be blended can be adjusted so that the oil-in-water emulsified seasoning of the invention has a desired β-carotene content.

The β-carotene content in the oil-and/or-fat used in the invention is preferably 10 to 130 mass ppm, more preferably 15 to 100 mass ppm, even more preferably 20 to 75 mass ppm, and most preferably 25 to 40 mass ppm. When the β-carotene content in the oil-and/or-fat is within the above ranges, the effects of the invention are easily obtained.

Lycopene

Lycopene contained in the continuous phase (the aqueous phase) of the oil-in-water emulsified seasoning of the invention is not specifically limited as long as it is edible lycopene. The lycopene is a type of carotenoid, and it is possible to use extracts derived from plants such as tomato, Japanese persimmon, watermelon and pink grapefruit, or chemically synthesized lycopene.

Lycopene is a highly lipid-soluble substance, but the present invention is characterized in that a specific amount of the lycopene is contained in the continuous phase (the aqueous phase), not in the oil-and/or-fat. As a method for incorporating lycopene into the continuous phase, e.g., a lycopene preparation in which lycopene crystals are dispersed in an aqueous medium using a gummy matter or an emulsifier can be added to the aqueous phase ingredients. Lycopene base NO. 34824 (manufactured by San-Ei Gen F.F.I., Inc.) and lycopene base NO. 35153 (manufactured by San-Ei Gen F.F.I., Inc.) can be listed as examples of the preparation in which lycopene crystals are dispersed in an aqueous medium.

For the lycopene used in the invention, it is preferable to use a water-soluble lycopene preparation (liquid) in which lycopene is dispersed in an aqueous solution containing a gummy matter such as gum arabic.

The presence of lycopene contained in the continuous phase (the aqueous phase) of the oil-in-water emulsified seasoning of the invention is confirmed by the following method. That is, the oil-in-water emulsified seasoning of the invention, which was frozen, and then thawed and demulsified, is centrifuged to separate the aqueous phase, and oil-soluble substances are further extracted from the aqueous phase using an organic solvent composed of hexane and acetone. Then, when a local maximum peak of absorbance of the extracted solution is observed at a wavelength of 470 nm, the presence is confirmed.

It can also be confirmed by performing an HPLC analysis on the solution extracted from the above aqueous phase, as described in J. Agric. Food Chem. (2001) 49 3713-17.

The lycopene content in the oil-in-water emulsified seasoning of the invention is 1 to 5 mass ppm. The lycopene content in the oil-in-water emulsified seasoning of the invention is preferably 1.2 to 4.5 mass ppm, more preferably 1.4 to 3.5 mass ppm, and most preferably 1.5 to 2.7 mass ppm. When the lycopene content is not less than 1 mass ppm, flavor degradation over time of the oil-in-water emulsified seasoning of the invention is further suppressed. On the other hand, the lycopene content of more than 5 mass ppm is not preferable because of strong red coloration.

When a lycopene preparation is used as an ingredient of the oil-in-water emulsified seasoning of the invention, the amount of the lycopene preparation to be blended can be adjusted so that the oil-in-water emulsified seasoning of the invention has a desired lycopene content.

The lycopene content in the continuous phase in the invention is preferably 2 to 10 mass ppm, more preferably 2.5 to 9 mass ppm, even more preferably 3 to 8 mass ppm, and most preferably 3.5 to 7 mass ppm. When the lycopene content in the continuous phase is within the above ranges, the effects of the invention are easily obtained.

A mass ratio of β-carotene to lycopene (β-carotene:lycopene) in the oil-in-water emulsified seasoning of the invention is preferably 1:1 to 25:1, more preferably 2:1 to 20:1, even more preferably 4:1 to 15:1, and most preferably 6:1 to 10:1. When the mass ratio of β-carotene to lycopene is within the above ranges, flavor degradation over time of the oil-in-water emulsified seasoning of the invention is further suppressed.

Amount of Water

The water content (the amount of water) in the oil-in-water emulsified seasoning of the invention is preferably 20 to 70 mass %, more preferably 22 to 60 mass %, even more preferably 24 to 50 mass %, and most preferably 26 to 38 mass %. The amount of water in the oil-in-water emulsified seasoning of the invention can be obtained as follows: 10 g of a sample is taken and placed on a petri dish, the weight is measured after heating at 105° C. for 4 hours, and the weight difference before and after the measurement is calculated.

Other Ingredients

Ingredients commonly used in dipping sauces or mayonnaise, etc., (except β-carotene and lycopene) may be blended in the oil-in-water emulsified seasoning of the invention. For example, dietary salt, vinegar, fruit juice, acidifier, umami flavor enhancer, protein hydrolysate, sugars, sweetener, extracts, milks, spices, thickening polysaccharides, antioxidant, and food materials (chopped vegetables, grated vegetables, etc.), etc., may be used as such ingredients.

The oil-in-water emulsified seasoning of the invention may contain egg yolk. However, to obtain a better effect of suppressing flavor degradation, it is preferable that the egg yolk content in the oil-in-water emulsified seasoning be not more than 5 mass %, and it is more preferable that egg yolk be not contained.

The oil-in-water emulsified seasoning of the invention preferably contains a modified starch with emulsifying power. An octenylsuccinic acid-treated starch can preferably be used as the modified starch. A content of the modified starch in the oil-in-water emulsified seasoning of the present invention is preferably 0.5 to 5 mass %, more preferably 0.7 to 4 mass %, and most preferably 1 to 3 mass %. When the modified starch content is within the above ranges, the effects of the invention are easily obtained.

Production Method

A method for producing the oil-in-water emulsified seasoning of the invention is a method for producing an oil-in-water emulsified seasoning containing 25 to 75 mass % of an oil-and/or-fat, 5 to 50 mass ppm of β-carotene and 1 to 5 mass ppm of lycopene, and is characterized by including a step of emulsifying the oil-and/or-fat containing the β-carotene (an oil phase) with an aqueous phase containing the lycopene. Alternatively, the method for producing the oil-in-water emulsified seasoning of the invention may include a step of dispersing the lycopene in a continuous phase after emulsifying the oil-and/or-fat containing the β-carotene (an oil phase) with an aqueous phase.

A specific example of the method for producing the oil-in-water emulsified seasoning of the invention will be described below.

In the method for producing the oil-in-water emulsified seasoning of the invention, the seasoning may be produced by a conventional method in which, e.g., all ingredients of the aqueous phase (including lycopene) are loaded into a heatable mixing tank, and these ingredients are then stirred and mixed while heating the mixing tank, thereby preparing the aqueous phase. The heating and stirring conditions are not specifically limited as long as it is possible to heat and stir as necessary to uniformly disperse, melt or sterilize the ingredients. The heating and stirring can be performed under increased pressure, reduced pressure and normal pressure, and is typically performed under normal pressure. The heating temperature is not specifically limited and heating is typically performed at 40 to 95° C., preferably 60° C. to 95° C. Heating may not be performed if not required. Stirring can be performed under the conditions which allow the ingredients to be melted or dispersed. It is possible to use a stirrer or method such as propeller, homomixer, blender, disper, paddle mixer, colloid mill, continuous mixer, static mixer and ultrasonic, etc., and the rotation speed and stirring time are not specifically limited. In case that the aqueous phase is heated, the aqueous phase is cooled to about ambient temperature after heating.

Separately from the preparation of the aqueous phase, a homogeneous oil phase is prepared by mixing ingredients of the oil phase (including the oil-and/or-fat and the β-carotene). Next, the prepared aqueous phase and oil phase are combined and emulsified together. Emulsification can be carried out by coarsely emulsifying with a mixer, etc., listed above and then finely emulsifying with a homomixer or colloid mill, etc., to finish, followed by filling and sealing a container, etc.

The oil-in-water emulsified seasoning of the invention may be hot-pack sterilized or retort-sterilized. The method of hot-pack sterilization of the oil-in-water emulsified seasoning and the material of packages, etc., are not specifically limited, and any conventionally known method and material can be used. The conditions for hot-fill processing (i.e., hot-fill packaging) are not specifically limited, neither, and may be conventionally known conditions, and it can be carried out, e.g., at a temperature of not less than 45° C., preferably at a temperature of not less than 60° C. The method of retort sterilization of the oil-in-water emulsified seasoning and the container used for retort sterilization are not specifically limited, and any conventionally known method, etc., can be used. The method of retort sterilization may be carried out, e.g., at 120° C. for 30 to 60 minutes, etc. It may alternatively be semi-retort processing at a temperature of 105 to 115° C. or high-temperature retort processing at a temperature of not less than 130° C.

### Examples

The invention will be described in more detail below in reference to Examples. However, the scope of the invention is not limited in any way to the Examples described below.

Oil-In-Water Emulsified Seasoning (Mayonnaise-Like Seasoning) Production-1

The oil-in-water emulsified seasonings (mayonnaise-like seasonings) of the invention were made according to the formulas given in Table 1. In particular, the ingredients of the aqueous phase were loaded into a container equipped with a stirrer and were mixed at ambient temperature for 10 minutes while being stirred by a paddle mixer at 100 rpm. Next, the separately prepared oil phase was added to the aqueous phase, the mixture was coarsely emulsified using a paddle mixer (100 rpm) under reduced pressure, then finely emulsified using a homomixer (5500 rpm) for 20 minutes to finish, and filled into plastic mayonnaise tubes, etc., thereby obtaining mayonnaise-like oil-in-water emulsified seasonings (Examples 1, 2 and Comparative Examples 1 to 3).

In particular, the following were used as ingredients shown in Table 1 to 3: rapeseed oil (product name: Nisshin Canola Oil, manufactured by The Nisshin OilliO Group, Ltd., the unsaturated fatty acid content in the total constituent fatty acids: 92.5 mass %), β-carotene preparation (product name: Carrot Oil NO. 40600, manufactured by San-Ei Gen F.F.I., Inc., the β-carotene content: 1 mass %), grain vinegar (product name: MHV-310, manufactured by Mizkan Co., Ltd.), hydrogenated starch syrup (product name: SE 600, manufactured by Nikken Chemical and Synthetic Industry Co., Ltd., the water content: 30 mass %), dietary salt (product name: Tokunoen, manufactured by Nippon Salt Manufacturing Co., Ltd.), modified starch (starch sodium octenyl succinate, product name: Trecomex Twelve 02, manufactured by Oji Cornstarch Co., Ltd.), thickening polysaccharide (xanthan gum, product name: Echo Gum GM, manufactured by DSP GOKYO FOOD & CHEMICAL Co., Ltd.), sodium glutamate (product name: GLUACE, manufactured by MC Food Specialties Incorporated), flavoring (product name: Mayonnaise paste AB86310 manufactured by Ogawa & Co., Ltd.), and lycopene preparation (product name: Lycopene base NO. 34824, manufactured by San-Ei Gen F.F.I., Inc., the lycopene content: 1 mass %, liquid).

The obtained products of oil-in-water emulsified seasonings (Examples 1, 2 and Comparative Examples 1 to 3) all had an acidity of about 0.75 expressed in terms of acetic acid, as a result of measuring by the above-described titration method. The viscosity (20° C.) of all the products was about 170 Pa·s as a result of measuring by the above-described method using a BH-type viscometer (manufactured by TOKYO KEIKI INC.). The water content of all the products was about 30 mass % as a result of measuring by the above-described heating and drying method.

Regarding Examples 1, 2, and Comparative Example 2, the products, which had been frozen, and then thawed and demulsified, were centrifuged to separate the aqueous phase, and then, the oil-soluble substances were extracted from the aqueous phase using an organic solvent composed of hexane and acetone. When absorbance of the extracted liquid was measured by a spectrophotometer (U-2000 manufactured by Hitachi, Ltd.), a local maximum peak was observed at a wavelength of 470 nm, thereby confirming that lycopene is contained in the aqueous phase.

The “β-carotene content” and the “lycopene content” in Table 1 mean the contents (mass ppm) in the oil-in-water emulsified seasonings.

TABLE 1

| | | Comparative | Comparative | Comparative | | |
|---|---|---|---|---|---|---|
| (mass %) | | Example 1 | Example 2 | Example 3 | Example 1 | Example 2 |
| Oil phase | Rapeseed oil | 60.0000 | 60.0000 | 60.0000 | 60.0000 | 60.0000 |
| | β-carotene preparation | — | — | 0.2200 | 0.1540 | 0.2200 |
| Aqueous | Grain vinegar | 6.8000 | 6.8000 | 6.8000 | 6.8000 | 6.8000 |
| phase | Hydrogenated starch | 6.6000 | 6.6000 | 6.6000 | 6.6000 | 6.6000 |
| | syrup | | | | | |
| | Dietary salt | 2.2000 | 2.2000 | 2.2000 | 2.2000 | 2.2000 |
| | Modified starch | 2.2000 | 2.2000 | 2.2000 | 2.2000 | 2.2000 |
| | Thickening | 0.2000 | 0.2000 | 0.2000 | 0.2000 | 0.2000 |
| | polysaccharide | | | | | |
| | Sodium glutamate | 0.4000 | 0.4000 | 0.4000 | 0.4000 | 0.4000 |
| | Flavoring | 0.3000 | 0.3000 | 0.3000 | 0.3000 | 0.3000 |
| | Lycopene preparation | — | 0.0250 | — | 0.1750 | 0.0250 |
| | Water | 21.3000 | 21.2750 | 21.0800 | 21.1285 | 21.0550 |

| | | | | | |
|---|---|---|---|---|---|
| Total | 100.0000 | 100.0000 | 100.0000 | 100.0000 | 100.0000 |
| β-carotene content (ppm) | — | — | 22 | 15.4 | 22 |
| Lycopene content (ppm) | — | 2.5 | — | 1.75 | 2.5 |

40° C. Storage Test of Oil-In-Water Emulsified Seasoning

As the storage test, an accelerated deterioration test was conducted by the following method. The oil-in-water emulsified seasonings made as described above were left to stand in a constant temperature bath (dark place) at 40° C. Then, peroxide value measurement and sensory evaluation were conducted on the oil-in-water emulsified seasonings after storage for 6 weeks and after storage for 8 weeks.

Peroxide Value (POV) Measurement of Oil-and/or-Fat in Oil-In-Water Emulsified Seasoning

Oil components were extracted from the oil-in-water emulsified seasonings which were stored for 6 weeks and 8 weeks in the 40° C. storage test, and the POV of the oil-and/or-fat (Standard methods for the analysis of fats, oils and related materials, 2.5.2.1-2003, Peroxide Value) was determined. The results are shown in Table 2.

Evaluation of Oil-In-Water Emulsified Seasoning

Sensory evaluation was conducted on the oil-in-water emulsified seasonings which were made as described above. The evaluation items selected were abnormal odor and abnormal taste (bitter astringency) which are likely to be affected by oxidative degradation of the oil-and/or-fat. For evaluation, five expert panels, who had passed the in-house taste test and olfactory test (using a standard odor for panel selection, manufactured by Daiichi Yakuhin Sangyo Co., Ltd.), ate about 5 g of each oil-in-water emulsified seasoning made as described above (product temperature 20° C.), and scored according to the scoring criteria below. Then, the average of the scores given by the five panels was calculated and evaluated according to the following evaluation criteria. The evaluation results are shown in Table 2.

In this regard, the controls used here were made according to the formula of Comparative Example 1 given in Table 1 using the production method described above and stored at 5° C. for 1 day. In addition, the peroxide value of the oil-and/or-fat in all the control oil-in-water emulsified seasonings was about 0.3.

Evaluation of Abnormal Odor Suppression—Scoring Criteria

The sensation associated with exhalation when eating oil-in-water emulsified seasoning
0 point: Abnormal odor stronger than that given 1 point is perceived, when compared to the control.
1 point: Abnormal odor is clearly perceived when compared to the control.
2 points: Abnormal odor is slightly perceived when compared to the control.
3 points: Odor is comparable to the control, and no abnormal odor is perceived.

Evaluation of abnormal odor suppression—Evaluation Criteria
⊚ (Excellent): 2.2-3.0
∘ (Good): 1.2-2.0
x (Bad): 0.0-1.0

Evaluation of abnormal taste (bitter astringency) suppression—Scoring Criteria
0 point: Bitter astringency stronger than that given 1 point is perceived, when compared to the control.
1 point: Bitter astringency is clearly perceived, when compared to the control.
2 points: Bitter astringency is slightly perceived, when compared to the control.
3 points: Taste is comparable to the control, and no bitter astringency is perceived.

Evaluation of abnormal taste (bitter astringency) suppression—Evaluation Criteria
⊚ (Excellent): 2.2-3.0
∘ (Good): 1.2-2.0
x (Bad): 0.0-1.0

Using the results of the sensory evaluations above, the comprehensive evaluation was conducted according to the following evaluation criteria. The results are shown in Table 2.

### Comprehensive Evaluation—Evaluation Criteria

⊚ (Excellent): Sensory evaluation results do not include any x and include at least one ⊚.
∘ (Good): Sensory evaluation results do not include any x and all results are ∘.
x (Bad): Any of the sensory evaluation results is x.

TABLE 2

| | Comparative | Comparative | Comparative | | |
|---|---|---|---|---|---|
| | Example 1 | Example 2 | Example 3 | Example 1 | Example 2 |
| Peroxide value of Oil-and/or-Fat | | | | | |
| 40° C., 6 weeks | 7.7 | 8.0 | 9.1 | 9.2 | 10.0 |
| 40° C., 8 weeks | 11.9 | 12.1 | 10.5 | 11.4 | 12.6 |
| Abnormal odor suppression | | | | | |
| 40° C., 6 weeks | ◯ (1.6) | ◯ (1.6) | ◯ (2.0) | ◯ (2.0) | ◯ (2.0) |
| 40° C., 8 weeks | X (0.8) | X (0.8) | X (1.0) | ◯ (1.8) | ◯ (1.8) |
| Abnormal taste (bitter astringency) | | | | | |
| suppression | | | | | |
| 40° C., 6 weeks | X (0.6) | X (0.8) | X (1.0) | ⊚ (2.2) | ⊚ (2.2) |
| 40° C., 8 weeks | X (0.2) | X (0.4) | X (0.6) | ◯ (2.0) | ◯ (2.0) |
| Comprehensive evaluation | | | | | |
| 40° C., 6 weeks | X | X | X | ⊚ | ⊚ |
| 40° C., 8 weeks | X | X | X | ◯ | ◯ |

Numerical values in parentheses are average scores.

The results in Table 2 show that the oil-in-water emulsified seasonings containing specific amounts of β-carotene and lycopene (Examples 1 and 2) had an excellent rich taste derived from the oil-and/or-fat. In addition, degradation in flavor was suppressed even though oxidative degradation (peroxide value) over time of the oil-and/or-fat was comparable with that of the oil-in-water emulsified seasonings in Comparative Examples.

Oil-In-Water Emulsified Seasoning (Mayonnaise-Like Seasoning) Production-2

According to the formula given in Table 3, a mayonnaise-like oil-in-water emulsified seasoning (Comparative Example 4) was obtained in the same manner as in “Oil-in-water emulsified seasoning (mayonnaise-like seasoning) production-1” described above. The ingredients in the table are of similar quality to those listed in Table 1, and an oil-soluble lycopene preparation used was “product name: Lyc-O-Mato 15%, manufactured by SUNBRIGHT CO., LTD., the lycopene content: 15 mass %, liquid”.

The obtained oil-in-water emulsified seasoning (Comparative Example 4) had an acidity of 0.75 expressed in terms of acetic acid, as a result of measuring by the above-described titration method. The viscosity (20° C.) was 170 Pa·s as a result of measuring by the above-described method using a BH-type viscometer (manufactured by TOKYO KEIKI INC.). The water content was 30 mass % as a result of measuring by the above-described heating and drying method.

Regarding Comparative Example 4, the product, which had been frozen, and then thawed and demulsified, was centrifuged to separate the aqueous phase, and then, the oil-soluble substances were extracted from the aqueous phase using an organic solvent composed of hexane and acetone. When absorbance of the extracted liquid was measured by a spectrophotometer (U-2000 manufactured by Hitachi, Ltd.), a local maximum peak was not observed at a wavelength of 470 nm, thereby confirming that lycopene is contained in the oil phase, not in the aqueous phase.

The “β-carotene content” and the “lycopene content” in Table 3 mean the contents (mass ppm) in the oil-in-water emulsified seasoning.

TABLE 3

| (mass %) | | Comparative Example 4 |
|---|---|---|
| Oil | Rapeseed oil | 60.0000 |
| phase | β-carotene preparation | 0.1540 |
| | Lycopene preparation | 0.0012 |
| Aqueous | Grain vinegar | 6.8000 |
| phase | Hydrogenated starch syrup | 6.6000 |
| | Dietary salt | 2.2000 |
| | Modified starch | 2.2000 |
| | Thickening polysaccharide | 0.2000 |
| | Sodium glutamate | 0.4000 |
| | Flavoring | 0.3000 |
| | Water | 21.1448 |

| | |
|---|---|
| Total | 100.0000 |
| β-carotene content (ppm) | 15.4 |
| Lycopene content (ppm) | 1.80 |

40° C. Storage Test of Oil-In-Water Emulsified Seasoning, and its Evaluation

The oil-in-water emulsified seasoning (Comparative Example 4) was subjected to the same storage test and evaluations as the storage test and various evaluations conducted on the oil-in-water emulsified seasonings (Examples 1, 2, and Comparative Examples 1 to 3) described above. The control used in sensory evaluation was made according to the formula of Comparative Example 1 given in Table 1 using the production method described above and stored at 5° C. for 1 day. The peroxide value of the oil-and/or-fat in the control oil-in-water emulsified seasoning was about 0.3. The evaluation results are shown in Table 4.

TABLE 4

| | Comparative Example 4 |
|---|---|
| Peroxide value of Oil-and/or-Fat | |
| 40° C., 6 weeks | 5.2 |
| 40° C., 8 weeks | 7.8 |
| Abnormal odor suppression | |
| 40° C., 6 weeks | ◯ (1.6) |
| 40° C., 8 weeks | ◯ (1.2) |
| Abnormal | |
| taste (bitter astringency) suppression | |
| 40° C., 6 weeks | X (1.0) |
| 40° C., 8 weeks | X (0.8) |
| Comprehensive evaluation | |
| 40° C., 6 weeks | X |
| 40° C., 8 weeks | X |

Numerical values in parentheses are average scores.

The results in Table 4 show that degradation in flavor over time was not suppressed in the oil-in-water emulsified seasoning that contains lycopene in the oil phase, not in the aqueous phase (Comparative Example 4).

Oil-In-Water Emulsified Seasoning (Mayonnaise-Like Seasoning) Production-3

According to the formula given in Table 5, a mayonnaise-like oil-in-water emulsified seasoning (Example 3) was obtained in the same manner as in “Oil-in-water emulsified seasoning (mayonnaise-like seasoning) production-1” described above. The ingredients in the table are of similar quality to those listed in Table 1.

The obtained oil-in-water emulsified seasoning (Example 3) had an acidity of 0.73 expressed in terms of acetic acid, as a result of measuring by the above-described titration method. The water content was 49 mass % as a result of measuring by the above-described heating and drying method.

Regarding Example 3, the product, which had been frozen, and then thawed and demulsified, was centrifuged to separate the aqueous phase, and then, the oil-soluble substances were extracted from the aqueous phase using an organic solvent composed of hexane and acetone. When absorbance of the extracted liquid was measured by a spectrophotometer (U-2000 manufactured by Hitachi, Ltd.), a local maximum peak was observed at a wavelength of 470 nm, thereby confirming that lycopene is contained in the aqueous phase.

The “β-carotene content” and the “lycopene content” in Table 5 mean the contents (mass ppm) in the oil-in-water emulsified seasoning.

TABLE 5

| (mass %) | | Example 3 |
|---|---|---|
| Oil | Rapeseed oil | 40.000 |
| phase | β-carotene preparation | 0.150 |
| Aqueous | Grain vinegar | 6.800 |
| phase | Hydrogenated starch syrup | 6.600 |
| | Dietary salt | 2.200 |
| | Modified starch | 2.200 |
| | Thickening polysaccharide | 0.300 |
| | Sodium glutamate | 0.400 |
| | Flavoring | 0.300 |
| | Lycopene preparation | 0.024 |
| | Water | 41.026 |

| | |
|---|---|
| Total | 100.000 |
| β-carotene content (ppm) | 15.0 |
| Lycopene content (ppm) | 2.4 |

40° C. Storage Test of Oil-In-Water Emulsified Seasoning, and its Evaluation

The oil-in-water emulsified seasoning (Example 3) was subjected to the storage test and evaluations in the similar manner to those described above. The control used in sensory evaluation was made according to the formula of Comparative Example 1 given in Table 1 using the production method described above and stored at 5° C. for 1 day. The peroxide value of the oil-and/or-fat in the control oil-in-water emulsified seasoning was 0.3. The evaluation results are shown in Table 6.

TABLE 6

| | Example 3 |
|---|---|
| Peroxide value of Oil-and/or-Fat | |
| 40° C., 6 weeks | 12.2 |
| Abnormal odor suppression | |
| 40° C., 6 weeks | ⊚ (2.2) |
| Abnormal | |
| taste (bitter astringency) suppression | |
| 40° C., 6 weeks | ◯ (1.6) |
| Comprehensive evaluation | |
| 40° C., 6 weeks | ⊚ |

Numerical values in parentheses are average scores.

The results in Table 6 show that the oil-in-water emulsified seasoning containing 40 mass % of rapeseed oil, 15.0 mass ppm of β-carotene and 2.4 mass ppm of lycopene (Example 3) exhibited suppressed flavor degradation over time and had an excellent rich taste derived from the oil-and/or-fat.

1. An oil-in-water emulsified seasoning, containing:
25 to 75 mass % of an oil-and/or-fat;
5 to 50 mass ppm of β-carotene; and
1 to 5 mass ppm of lycopene,
wherein the β-carotene is contained in the oil-and/or-fat and the lycopene is contained in a continuous phase.

2. The oil-in-water emulsified seasoning according to claim 1, further containing:
0.5 to 5 mass % of a modified starch.

3. The oil-in-water emulsified seasoning according to claim 1, wherein an unsaturated fatty acid content in the total constituent fatty acids of the oil-and/or-fat is not less than 65 mass %.

4. A method for producing the oil-in-water emulsified seasoning containing 25 to 75 mass % of an oil-and/or-fat, 5 to 50 mass ppm of β-carotene, and 1 to 5 mass ppm of lycopene, wherein the β-carotene is contained in the oil-and/or-fat and the lycopene is contained in a continuous phase, the method comprising:
emulsifying an oil phase containing the oil-and/or-fat and the β-carotene, and an aqueous phase containing the lycopene.

5. The oil-in-water emulsified seasoning according to claim 2, wherein an unsaturated fatty acid content in the total constituent fatty acids of the oil-and/or-fat is not less than 65 mass %.

6. The method according to claim 4, wherein the oil-in-water emulsified seasoning further contains 0.5 to 5 mass % of a modified starch.

7. The method according to claim 6, wherein an unsaturated fatty acid content in the total constituent fatty acids of the oil-and/or-fat is not less than 65 mass %.

8. The method according to claim 7, wherein an unsaturated fatty acid content in the total constituent fatty acids of the oil-and/or-fat is not less than 65 mass %.
